(19) United States
(12) Patent Application Publication
(10) Pub. No.: US 2025/0231784 A1
(43) Pub. Date: Jul. 17, 2025

(54) Restartable Message Aggregation Flows in Containers

(71) Applicant: International Business Machines Corporation, Armonk, NY (US)

(72) Inventors: Benjamin Graham Thompson, Eastleigh (GB); Julian Hill, Alresford (GB); Collins N. Aniro, Salford (GB); James Richard Sheppard, Sheffield (GB)

(21) Appl. No.: 18/415,151

(22) Filed: Jan. 17, 2024

(51) Int. Cl. G06F 9/455; G06F 9/54

(52) U.S. Cl. CPC G06F 9/45558; G06F 9/546; G06F 2009/4557; G06F 2009/45595

(57) ABSTRACT

Controlling message aggregation flows is provided. In response to determining that all of a plurality of independently identifiable related fan-in messages corresponding to an input message requesting information have been received as a complete set of reply messages from a plurality of back-end servers containing the information by a particular set of queues in a message queue manager container based on tracking of the plurality of independently identifiable related fan-in messages, the complete set of reply messages containing the information from the particular set of queues is retrieved using a fan-in message flow. The complete set of reply messages containing the information is aggregated using the fan-in message flow to generate a single response message containing the information. The single response message containing the information is sent to a client device requesting the information via a network.

### BACKGROUND

The disclosure relates generally to container-based architectures and more specifically to message aggregation flows in containers.

A container-based architecture, environment, platform, or the like, such as, for example, Kubernetes® (a registered trademark of the Linux Foundation of San Francisco, CA, USA), provides a structural design for automating deployment, scaling, and operations of containers across host nodes. A host node is a machine, either physical or virtual, where containers (i.e., application workloads) are deployed. A container is the lowest level of a microservice, which holds the running application, libraries, and their dependencies.

### SUMMARY

According to one illustrative embodiment, a computer-implemented method for controlling message aggregation flows is provided. In response to a computer, using a fan-in message flow of an integration engine in a replica container, determining that all of a plurality of independently identifiable related fan-in messages corresponding to an input message requesting information have been received as a complete set of reply messages from a plurality of back-end servers containing the information by the particular set of queues in a message queue manager container based on tracking of the plurality of independently identifiable related fan-in messages, the computer, using the fan-in message flow of the integration engine in the replica container, retrieves the complete set of reply messages containing the information from the particular set of queues in the message queue manager container. The computer, using the fan-in message flow of the integration engine in the replica container, aggregates the complete set of reply messages containing the information to generate a single response message containing the information. The computer sends the single response message containing the information to a client device requesting the information via a network. According to other illustrative embodiments, a computer system and computer program product for controlling message aggregation flows are provided.

### BRIEF DESCRIPTION OF THE DRAWINGS

FIG. 1 is a pictorial representation of a computing environment in which illustrative embodiments may be implemented;

FIG. 2 is a diagram illustrating an example of a message aggregation flow control system in accordance with an illustrative embodiment;

FIGS. 3A-3C are a diagram illustrating a process for controlling message aggregation flows in accordance with an illustrative embodiment; and

FIGS. 4A-4C are a flowchart illustrating a process for starting containers in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

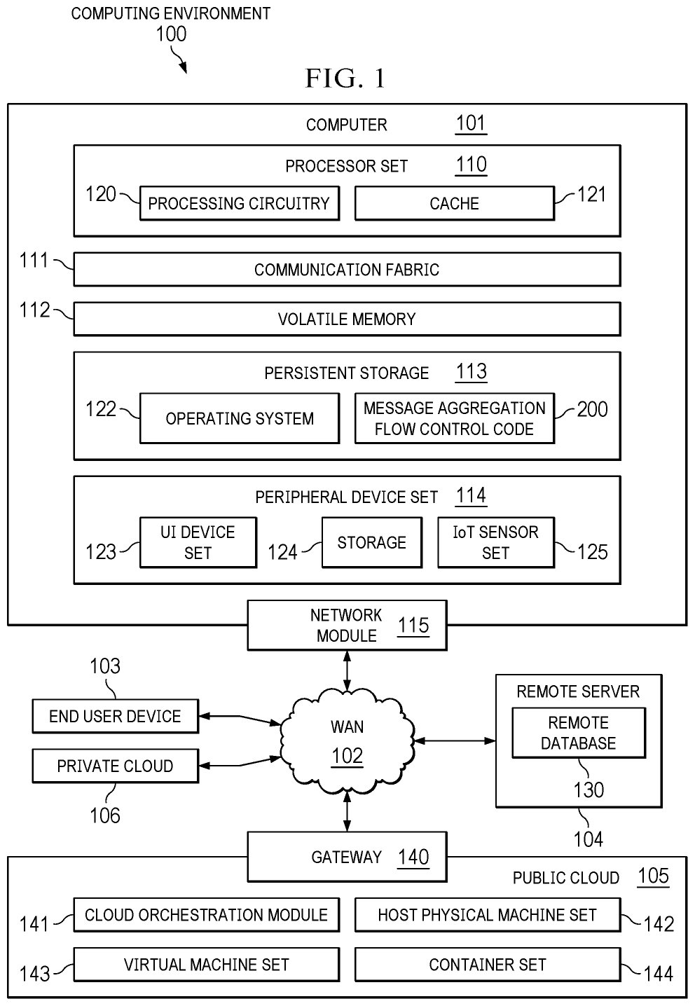

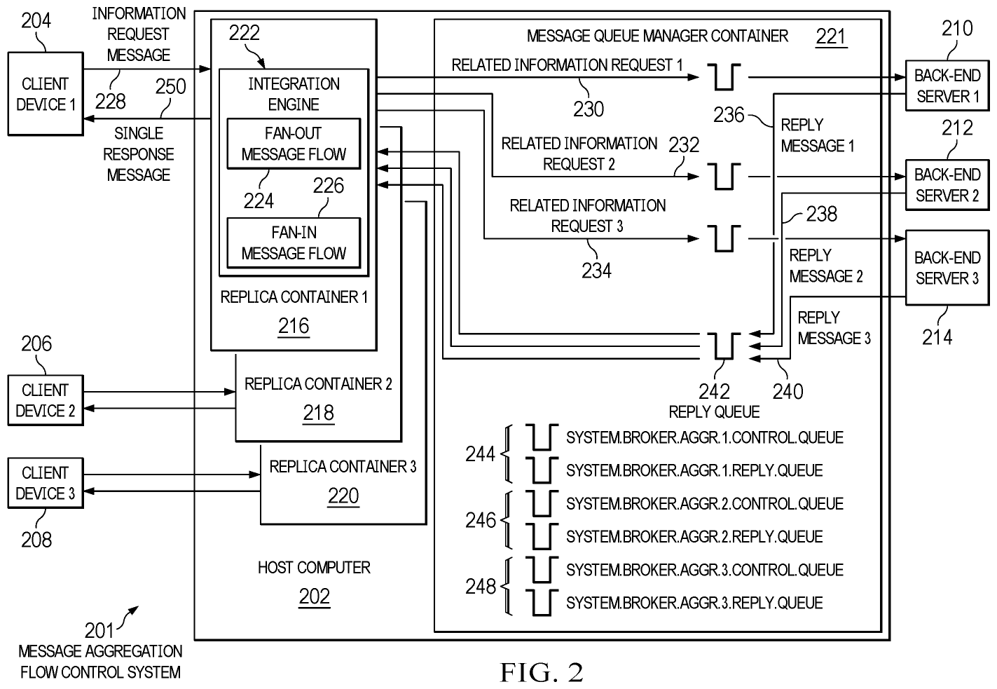

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of a container-based architecture for the execution of at least some of the computer code involved in performing the inventive methods of illustrative embodiments, such as message aggregation flow control code 200. For example, message aggregation flow control code 200 enables restartable message aggregation flows in the container-based architecture, while avoiding the need for dedicated persistent storage to be mounted in each separate running container to track the message aggregation flows.

In addition to message aggregation flow control code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and message aggregation flow control code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in message aggregation flow control code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a customer of an entity that operates computer 101), and may take any of the forms discussed above in connection with computer 101. EUD 103 typically receives helpful and useful data from the operations of computer 101. For example, in a hypothetical case where computer 101 is designed to provide aggregated information to the end user in a single response message, this aggregated information would typically be communicated from network module 115 of computer 101 through WAN 102 to EUD 103. In this way, EUD 103 can display, or otherwise present, the aggregated information to the end user. In some embodiments, EUD 103 may be a client device, such as thin client, heavy client, mainframe computer, desktop computer, laptop computer, tablet computer, smart phone, smart watch, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide aggregated information based on data, then this data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments.

Current message aggregation solutions utilize a fan-out message flow to receive an input message from a requesting application located on a client device. The input message is a request for information. The fan-out message flow generates a plurality of related information requests, which are derived from the original request for information received from the requesting application, and sends the plurality of related information requests to a set of back-end servers. The set of back-end servers is responsible for sending reply messages corresponding to the related information requests. Current message aggregation solutions propagate an aggregation identifier, which is associated with the initially received input message, with each back-end related information request. Each back-end server includes that same aggregation identifier in its reply message to the information request.

Current message aggregation solutions utilize a fan-in message flow to receive the reply messages, which correspond to the initial request for information in the original input message, from the back-end servers and collate the received reply messages to generate a single aggregated reply message (i.e., output message). Current message aggregation solutions then send the single aggregated reply message to the initial requesting application via the client device.

Current message aggregation solutions are responsible for maintaining the state of the back-end requests, which includes storing how many back-end requests have been made and how many corresponding reply messages have been received while further reply messages are being waited upon. As reply messages are received from the back-end servers, current message aggregation solutions write the reply messages to a reply queue for high availability. If the computer, which is running the fan-out and fan-in message flows, fails during the period when reply messages are being received from the back-end servers, then current message aggregation solutions will restart the computer using a high availability manager. The current state of the aggregation (including both the already received messages, the total messages expected, and therefore the number of messages still waiting to be received) is not lost as current message aggregation solutions recover the queued messages from a message queue manager. However, current message aggregation solutions require a local message queue manager underpinned by a dedicated persistent storage (e.g., disk system), which current message aggregation solutions must remount in the computer when the high availability manager of current message aggregation solutions restarts the computer, to track information regarding messages corresponding to the fan-out and fan-in message flows.

Even though current message aggregation solutions are workable for a centralized monolithic enterprise service bus architecture, current message aggregation solutions do not scale well when an integration engine, which is running the fan-out and fan-in message flows, is architected for operation within its own container (and scaled to exploit multiple replica containers) in, for example, a container-based architecture, environment, platform, or the like such as Kubernetes. In other words, current container-based architectures need additional requirements. For example, current container-based architectures may want to independently place the integration engine in its own container separately from the message queue manager, which would have its own container as well. In addition, current container-based architectures may want to utilize a set of replica containers for the integration engine to reduce cost. To further reduce cost, current container-based architectures may not want to mount a dedicated persistent storage to track messages corresponding to the fan-out and fan-in message flows in each replica container.

When a new replacement replica container for the integration engine running a message aggregation is restarted on the computer, the integration engine of this new replacement replica container needs to recover the state of any in-flight messages from the message queue manager container. As a result, the new replacement replica container needs to be identifiable as a replacement for its predecessor replica container so that the integration engine of the new replacement replica container can link to the same set of message queues in the message queue manager container to resume working on the existing in-flight message aggregations. Thus, current container-based architectures would need to be able to share a single message queue manager container between multiple replica containers running the integration engine.

Illustrative embodiments provide running restartable message aggregation flows in the container-based architecture, without needing a persistent volume claim for dedicated persistent storage to be mounted in each separate running replica container of a plurality of replica containers in the container-based architecture, thus avoiding the need for stateful containers. For example, when the container-based architecture starts a new replacement replica container, which includes the integration engine of illustrative embodiments, as part of a plurality of replica containers in the container-based architecture, it is currently not possible for the container-based architecture to provide a replica container identifier (e.g., replica container number such as 1, 2, 3 or any other form of stateful variable), which is carried forward from the previous replica container which went down and is being replaced, to the newly started replacement replica container.

As an illustrative example, assume that 3 replica containers (e.g., replica container 1, replica container 2, and replica container 3) are up and running in the container-based architecture. However, replica container 2 suddenly fails for some reason. The container-based architecture is responsible for starting a new replica container as a replacement for replica container 2 that just went down. Ideally, the container-based architecture would want to identify the new replacement replica container with the number 2 because replica container 1 and replica container 3 are still running and available. However, the container-based architecture is not currently capable of identifying the new replacement container with the number 2.

Illustrative embodiments on the other hand provide a mechanism for the new replacement replica container to determine how the new replacement replica container should assign itself the message aggregation state that it needs (i.e., connect to the same set of queues in the message queue manager container that the replica container, which went down and is being replaced, was connected to previously). When the new replacement replica container starts, the new replacement replica container attempts to open in turn each set of message aggregation queues, which can possibly correspond to another running replica container, in an attempt to find an unused set of message aggregation queues (i.e., a given set of message aggregation queues not utilized by another running replica container in the container-based architecture). For example, the message queue manager container is capable of reporting which replica containers are currently connected to which particular set of message aggregation queues in the message queue manager container. The new replacement replica container would not open a set of message aggregation queues currently connected to by another running replica container and move on to query the next set of message aggregation queues.

Thus, illustrative embodiments are able to take into account and address the issues related to current container-based architectures by enabling independent scaling of the integration engine in its own replica container separately from the message queue manager in its own stateful container. Moreover, illustrative embodiments avoid the need for any replica container-specific dedicated persistent storage requirement to track messages for the fan-in and fan-out message flows. Further, illustrative embodiments enable the sharing of a single message queue manager container for message aggregation purposes across a plurality of replica containers. As a result, illustrative embodiments enable a stateless integration engine replica container to resume a message aggregation workload without having to maintain the state of the message aggregation workload within the integration engine replica container, itself. Accordingly, illustrative embodiments save the cost of having to dedicate and mount persistent storage into each respective replica container. Moreover, because the persistent storage is outside the scaled replicas of the integration engine, the message queue manager can be placed in the architecture in a centralized computer outside the cluster entirely, while still network connected, if the user wanted to.

As an illustrative example, illustrative embodiments provide support for a plurality of replica containers. The plurality of replica containers provides a declarative method of defining the number of replica containers that should be running in the container-based architecture at any given time. Each respective replica container of the plurality of replica containers runs the same integration engine using the same code and the same configuration. Illustrative embodiments utilize the plurality of replica containers for scaling purposes to enable multiple copies of the integration engine to all be running at the same time in the container-based architecture. Illustrative embodiments assign each replica container a guaranteed processor and memory allocation.

The integration engine running in each of the replica containers aggregates reply messages received from a plurality of back-end servers. Typically, the back-end servers are located outside the container-based architecture. However, in alternative illustrative embodiments the back-end servers are hosted within the container-based architecture. In this illustrative example, the back-end servers communicate via asynchronous message queueing. Also, in this illustrative example the back-end servers are providing car insurance quotes in reply messages, which are in response to a car insurance quote request containing information, such as, for example, driver identifier and location, type of vehicle, past accident history, and the like, received from a client device via a network. Further in this illustrative example, there are 3 separate back-end insurance provider servers, which are all online and available at the same time and expecting to receive corresponding car insurance quote requests via the message queue manager container. In response to the original car insurance quote request received from the client device, each respective back-end insurance provider server sends a reply message, which contains a car insurance quote of that particular insurance provider, to the message queue manager container.

The integration engine in a given replica container has deployed message flows. A message flow is a sequence of building blocks that together solve an end-to-end integration problem. In this illustrative example, there are two message flows. The first message flow is a fan-out message flow of the integration engine. The fan-out message flow receives the information request message from the client device via the network. The fan-out message flow then generates and outputs 3 related messages corresponding to the original information request to the 3 back-end insurance provider servers via the message queue manager container. In other words, the fan-out message flow sends a first related message of the 3 related messages corresponding to the original information request to a first back-end insurance provide server, a second related message of the 3 related messages corresponding to the original information request to a second back-end insurance provide server, and a third related message of the 3 related messages corresponding to the original information request to a third back-end insurance provide server via the message queue manager container.

The second message flow of the integration engine is a fan-in message flow. The fan-in message flow receives a reply message from each of the 3 back-end insurance provider servers. It should be noted that the 3 related messages corresponding to the original information request sent to the 3 back-end insurance provider servers include an aggregation identifier. Illustrative embodiments utilize the aggregation identifier to correlate the 3 separate related messages corresponding to the original information request sent to the 3 back-end insurance provider servers with the corresponding reply messages received from the 3 back-end insurance provider servers. Further, it should be noted that a plurality of request messages and a plurality of reply messages can be in-flight at the same time. In other words multiple sets of the 3 request messages and multiple sets of 3 reply messages can be in-flight all at the same time within the container-based architecture.

Each time the integration engine of illustrative embodiments invokes the fan-out message flow in response to receiving an information request (e.g., car insurance quote) from a client device, the integration engine records the aggregation identifier on a queue named, for example, SYSTEM.BROKER.AGGR.1.CONTROL.QUEUE, which the integration engine is going to use when replica container 1 of the integration engine sends the 3 related messages corresponding to the original information request to the back-end insurance provider servers via the message queue manager container. The fan-out message flow of the integration engine can also record other information, such as, for example, the number of back-end request messages sent, a defined timeout period for the aggregation flow, and the like. In the event the defined timeout period is reached without all 3 reply messages having been received from the 3 back-end insurance provider servers, the fan-in message flow of the integration engine, which includes a timeout handler, generates a timeout message and sends the timeout message, along with a partial response, to the initial requesting client device.

In response to a particular back-end insurance provider server generating a reply message corresponding to the initial car insurance quote request received from the client device, that particular back-end insurance provider server writes the reply message to a particular reply queue of the message queue manager container. That particular reply queue of the message queue manager container feeds the fan-in message flow of the integration engine located in replica container 1. Each replica container utilizes the fan-in message flow of the integration engine to read the inbound reply messages from its corresponding reply queue. In other words, each particular fan-in message flow only retrieves reply messages from the reply queue that is utilized by its corresponding replica container. Each related message corresponding to the original information request that is sent to a back-end insurance provider server from a particular replica container includes a replica container identifier corresponding to that particular replica container. The fan-in message flow of that particular replica container utilizes that same replica container identifier when performing a GET operation from the reply queue utilized by that particular replica container. The replica container identifier can be associated with the unique hostname corresponding to that particular replica container. This ensures that the fan-in message flow of that particular replica container will only ever retrieve reply messages from the reply queue corresponding to that particular replica container.

In response to the 3 back-end insurance provider servers generating all 3 of the reply messages and persisting the reply messages in a particular reply queue named, for example, SYSTEM.BROKER.AGGR.1.REPLY.QUEUE, of the message queue manager container utilized by the fan-in message flow of replica container 1, the fan-in message flow retrieves and processes each reply message in that particular reply queue. So far in this illustrative example, a particular set of queues (i.e., a SYSTEM.BROKER.AGGR.1.CONTROL.QUEUE and a SYSTEM.BROKER.AGGR.1.REPLY.QUEUE) have been discussed in relation to utilization by the fan-in message flow of replica container 1. However, it should be noted that each particular replica container utilizes its own particular set of queues located in the message queue manager container. For example, replica container 2 utilizes a different set of queues in the message queue manager container that includes SYSTEM.BROKER.AGGR.2.CONTROL.QUEUE and SYSTEM.BROKER.AGGR.2.REPLY.QUEUE. Similarly, replica container 3 utilizes yet another set of queues in the message queue manager container that includes SYSTEM.BROKER.AGGR.3.CONTROL.QUEUE and SYSTEM.BROKER.AGGR.3.REPLY.QUEUE.

When a particular back-end insurance provider server persists a reply message corresponding to a particular fan-in message flow to a particular reply queue (e.g., SYSTEM.BROKER.AGGR.X.REPLY.QUEUE), the message queue manager monitors and compares the known total number of needed reply messages from a particular corresponding control queue (e.g., SYSTEM.BROKER.AGGR.X.CONTROL.QUEUE). It should be noted that X in this illustrative example is 1, 2, or 3. If all 3 of the reply messages have been received from the 3 back-end insurance provider servers, the fan-in message flow of that particular replica container combines all 3 reply messages into a single response message and sends that single response message back to the initial client device requesting the car insurance quote. Alternatively, if the timeout period has been reached and not all of the reply messages have been returned by the back-end insurance provider servers, then the fan-in message flow of that particular replica container combines only those reply messages that have been returned thus far and sends a partial response message back to the requesting client device.

In the event that only some of the back-end insurance provider servers (e.g., 2 of the 3 back-end insurance provider servers) have returned a reply message and the replica container, which is processing this set of reply messages, goes down (it is not important what caused the replica container to fail), the container-based architecture starts a new replica container to replace the one that went down. When the container-based architecture starts the new replacement replica container, the new instance of the integration engine in the new replacement replica container utilizes the same particular set of queues in the message queue manager container that was previously used by the replica container that went down and was currently storing the 2 of the 3 reply messages.

When the container-based architecture starts the new replacement replica container as part of the plurality of replica containers in the container-based architecture, it is currently not possible for the container-based architecture to provide a replica container identifier (e.g., 1, 2, or 3 or any other form of stateful variable which is carried forward from the previous replica container that went down and is being replaced) to the newly started replacement replica container. Instead, when the container-based architecture starts the new replacement replica container, illustrative embodiments direct the new replacement container to consult a GENERAL.CONTROL queue in the message queue manager container to determine the identifiers (e.g., 1, 2, 3, or the like) of the SYSTEM.AGGR.X.CONTROL.QUEUES that have previously been utilized by replica containers and attempts to open in turn each set of queues looking for a given set of queues that are not currently being utilized by a running replica container.

The message queue manager container is capable of reporting which replica container is currently connected to which particular set of queues. The new replacement replica container will not open a set of queues if that set of queues is being utilized by another running replica container. Instead, the new replacement replica container moves on to query the next set of queues. Once the new replacement replica container connects to the correct set of queues in the message queue manager container, the fan-in message flow of the new replacement replica container starts to monitor that particular set of queues for received reply messages from the back-end insurance provider servers until all of the needed reply messages have arrived or until the timeout period has been exceeded.

Thus, illustrative embodiments provide one or more technical solutions that overcome a technical problem with current container-based architectures needing to mount dedicated persistent storage in each container to track corresponding message flows. As a result, these one or more technical solutions provide a technical effect and practical application in the field of container-based architectures.

With reference now to FIG. 2, a diagram illustrating an example of a message aggregation flow control system is depicted in accordance with an illustrative embodiment. Message aggregation flow control system 201 may be implemented in a computing environment, such as computing environment 100 in FIG. 1. Message aggregation flow control system 201 is a system of hardware and software components for enabling restartable message aggregation flows in the container-based architecture, without needing dedicated persistent storage to be mounted in each separate running container to track corresponding message aggregation flows.

In this example, message aggregation flow control system 201 includes host computer 202, client device 1 204, client device 2 206, client device 3 208, back-end server 1 210, back-end server 2 212, and back-end server 3 214. Host computer 202 may be, for example, computer 101 in FIG. 1. Client device 1 204, client device 2 206, and client device 3 208 may be, for example, EUD 103 in FIG. 1. Back-end server 1 210, back-end server 2 212, and back-end server 3 214 may be, for example, remote server 104 in FIG. 1. However, it should be noted that message aggregation flow control system 201 is intended as an example only and not as a limitation on illustrative embodiments. For example, message aggregation flow control system 201 can include any number of host computers, client devices, back-end servers, and other devices and components not shown.

In this example, host computer 202 includes replica container 1 216, replica container 2 218, replica container 3 220, and message queue manager container 221. Replica container 1 216, replica container 2 218, and replica container 3 220 represent a plurality of replica containers hosted by host computer 202. In addition, each of replica container 1 216, replica container 2 218, and replica container 3 220 run an instance of integration engine 222 even though not shown in replica container 2 218 and replica container 3 220 in this example. Further, each instance of integration engine 222 in replica container 1 216, replica container 2 218, and replica container 3 220 includes fan-out message flow 224 and fan-in message flow 226.

In this example, client device 1 204 sends information request message 228 to host computer 202. Information request message 228 can represent a request for any type of information, such as, for example, a car insurance quote or the like. Host computer 202 utilizes fan-out message flow 224 of integration engine 222 to analyze information request message 228 and generate a plurality of independently identifiable related fan-out messages corresponding to information request message 228. In this example, the plurality of independently identifiable related fan-out messages corresponding to information request message 228 include related information request 1 230, related information request 2 232, and related information request 3 234. Fan-out message flow 224 sends related information request 1 230, related information request 2 232, and related information request 3 234 corresponding to information request message 228 to back-end server 1 210, back-end server 2 212, and back-end server 3 214, respectively, via message queue manager container 221. It should be noted that back-end server 1 210, back-end server 2 212, and back-end server 3 214 are each operated by a different entity (e.g., a different insurance provider). Back-end server 1 210, back-end server 2 212, and back-end server 3 214 contain the information (e.g., auto insurance cost information) requested by client device 1 204.

Back-end server 1 210 generates reply message 1 236, back-end server 2 212 generates reply message 2 238, and back-end server 3 214 generates reply message 3 240 in response to receiving related information request 1 230, related information request 2 232, and related information request 3 234, respectively. Reply message 1 236, reply message 2 238, and reply message 3 240 represent a plurality of independently identifiable related fan-in messages corresponding to information request message 228.

Back-end server 1 210, back-end server 2 212, and back-end server 3 214 send reply message 1 236, reply message 2 238, and reply message 3 240 corresponding to information request message 228 to reply queue 242 for retrieval by fan-in message flow 226. In this example, reply queue 242 represents set of queues 244, which is utilized only by replica container 1 216 based on a replica container identifier corresponding to replica container 1 216 that was assigned to set of queues 244. Similarly, set of queues 246 is utilized only by replica container 2 218 and set of queues 248 is utilized only by replica container 3 220.

Fan-in message flow 226 retrieves reply message 1 236, reply message 2 238, and reply message 3 240 corresponding to information request message 228 from reply queue 242. In response to retrieving reply message 1 236, reply message 2 238, and reply message 3 240 corresponding to information request message 228 from reply queue 242, fan-in message flow 226 aggregates reply message 1 236, reply message 2 238, and reply message 3 240 to generate single response message 250, which corresponds to information request message 228. Afterward, replica container 1 216 sends single response message 250 from host computer 202 to client device 1 204 as a response to information request message 228.

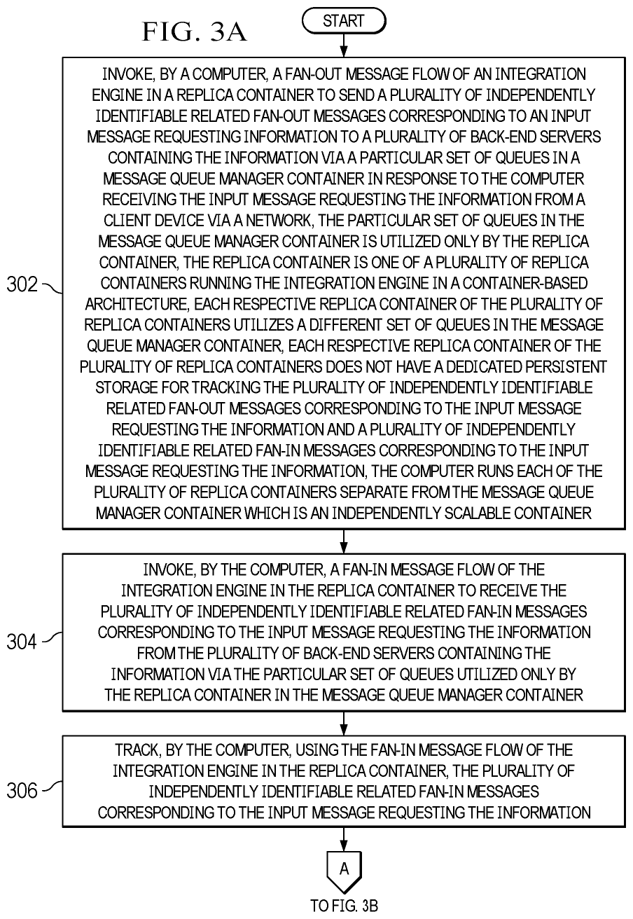

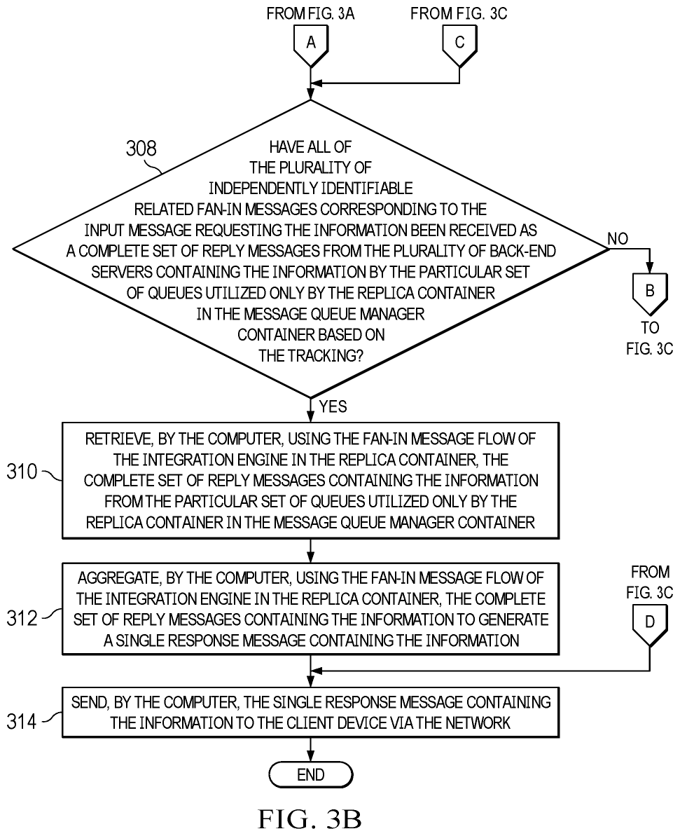

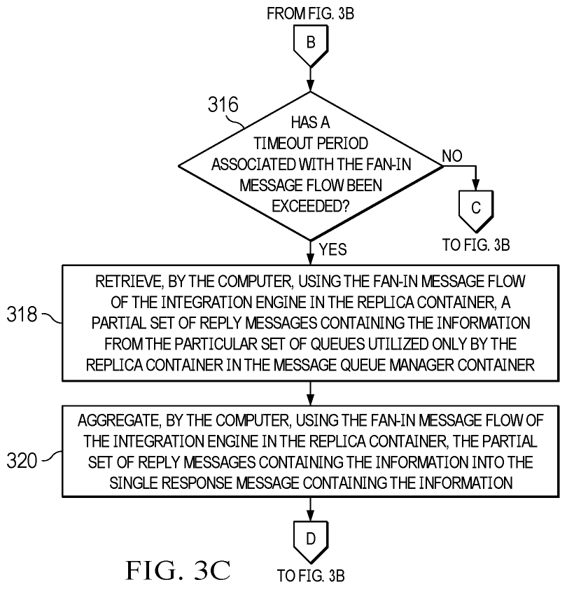

With reference now to FIGS. 3A-3C, a flowchart illustrating a process for controlling message aggregation flows is shown in accordance with an illustrative embodiment. The process shown in FIGS. 3A-3C may be implemented in a computer, such as, for example, computer 101 in FIG. 1 or host computer 202 in FIG. 2. For example, the process shown in FIGS. 3A-3C may be implemented by message aggregation flow control code 200 in FIG. 1.

The process begins when the computer invokes a fan-out message flow of an integration engine in a replica container to send a plurality of independently identifiable related fan-out messages corresponding to an input message requesting information to a plurality of back-end servers containing the information via a particular set of queues in a message queue manager container in response to the computer receiving the input message requesting the information from a client device via a network (step 302). The particular set of queues in the message queue manager container is utilized only by the replica container. The replica container is one of a plurality of replica containers running the integration engine in a container-based architecture. Each respective replica container of the plurality of replica containers utilizes a different set of queues in the message queue manager container. Each respective replica container of the plurality of replica containers does not have a dedicated persistent storage for tracking the plurality of independently identifiable related fan-out messages corresponding to the input message requesting the information and a plurality of independently identifiable related fan-in messages corresponding to the input message requesting the information. The computer runs each of the plurality of replica containers separate from the message queue manager container which also is an independently scalable container.

In addition, the computer invokes a fan-in message flow of the integration engine in the replica container to receive the plurality of independently identifiable related fan-in messages corresponding to the input message requesting the information from the plurality of back-end servers containing the information via the particular set of queues utilized only by the replica container in the message queue manager container (step 304). Further, the computer, using the fan-in message flow of the integration engine in the replica container, tracks the plurality of independently identifiable related fan-in messages corresponding to the input message requesting the information (step 306).

The computer, using the fan-in message flow of the integration engine in the replica container, makes a determination as to whether all of the plurality of independently identifiable related fan-in messages corresponding to the input message requesting the information have been received as a complete set of reply messages from the plurality of back-end servers containing the information by the particular set of queues utilized only by the replica container in the message queue manager container based on the tracking of the plurality of independently identifiable related fan-in messages (step 308). If the computer, using the fan-in message flow of the integration engine in the replica container, determines that all of the plurality of independently identifiable related fan-in messages corresponding to the input message requesting the information have been received as a complete set of reply messages from the plurality of back-end servers containing the information by the particular set of queues utilized only by the replica container in the message queue manager container based on the tracking of the plurality of independently identifiable related fan-in messages, yes output of step 308, then the computer, using the fan-in message flow of the integration engine in the replica container, retrieves the complete set of reply messages containing the information from the particular set of queues utilized only by the replica container in the message queue manager container (step 310).

The computer, using the fan-in message flow of the integration engine in the replica container, aggregates the complete set of reply messages containing the information to generate a single response message containing the information (step 312). The computer sends the single response message containing the information to the client device via the network (step 314). Thereafter, the process terminates.

Returning again to step 308, if the computer, using the fan-in message flow of the integration engine in the replica container, determines that all of the plurality of independently identifiable related fan-in messages corresponding to the input message requesting the information have not been received as a complete set of reply messages from the plurality of back-end servers containing the information by the particular set of queues utilized only the replica container in the message queue manager container based on the tracking of the plurality of independently identifiable related fan-in messages, no output of step 308, then the computer, using the fan-in message flow of the integration engine in the replica container, makes a determination as to whether a timeout period associated with the fan-in message flow has been exceeded (step 316). If the computer, using the fan-in message flow of the integration engine in the replica container, determines that the timeout period associated with the fan-in message flow has not been exceeded, no output of step 316, then the process returns to step 308 where the computer, using the fan-in message flow of the integration engine in the replica container, determines whether all of the plurality of independently identifiable related fan-in messages corresponding to the input message requesting the information have been received or not.

If the computer, using the fan-in message flow of the integration engine in the replica container, determines that the timeout period associated with the fan-in message flow has been exceeded, yes output of step 316, then the computer, using the fan-in message flow of the integration engine in the replica container, retrieves a partial set of reply messages containing the information from the particular set of queues utilized only by the replica container in the message queue manager container (step 318). The computer, using the fan-in message flow of the integration engine in the replica container, aggregates the partial set of reply messages containing the information into the single response message containing the information (step 320). Thereafter, the process returns to step 314 where the computer sends the single response message containing the information to the client device via the network.

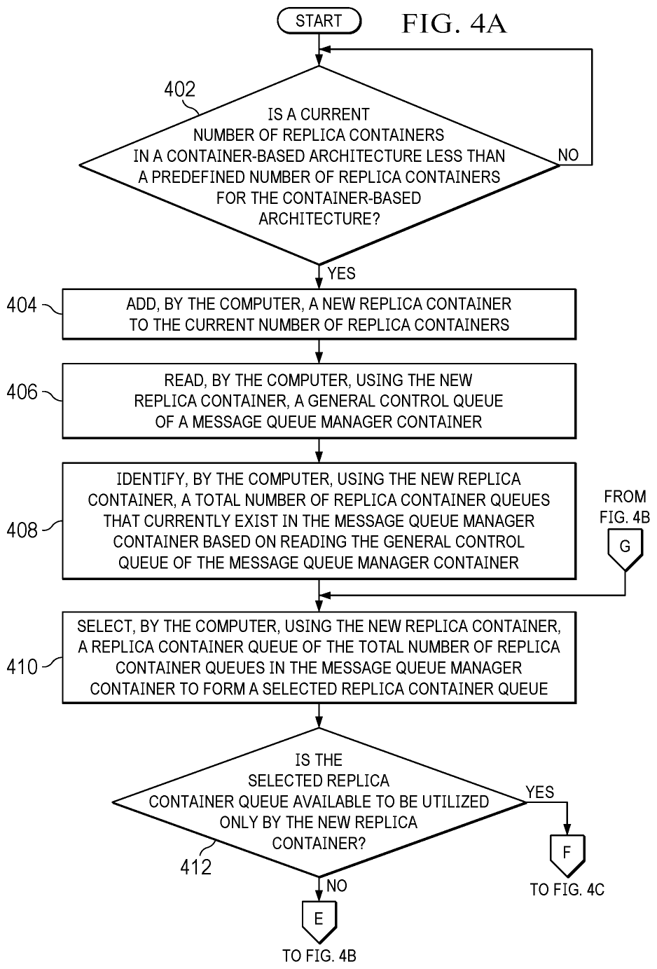

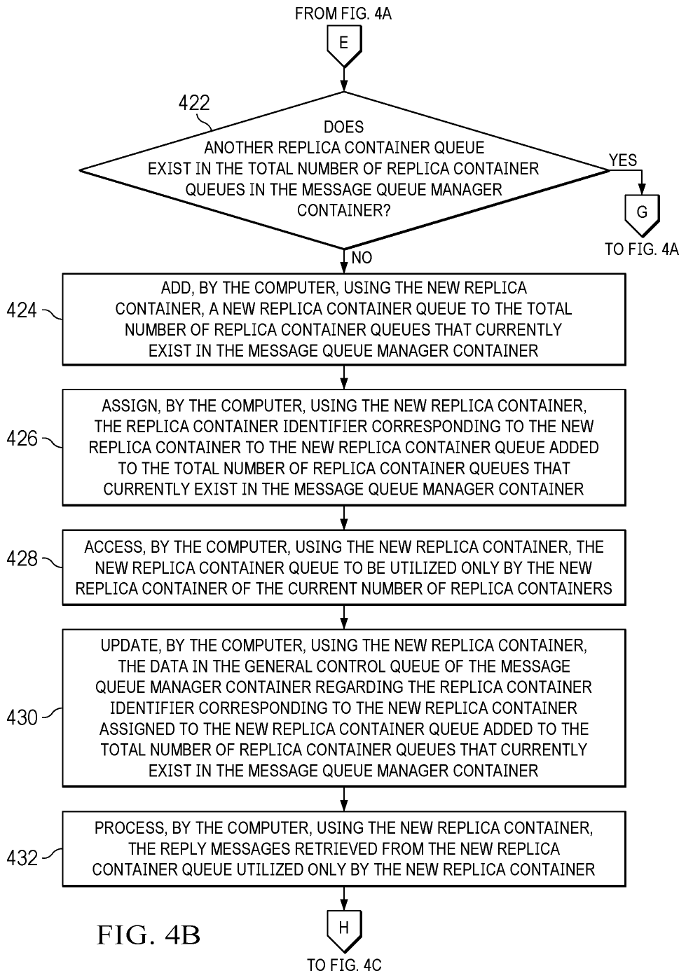

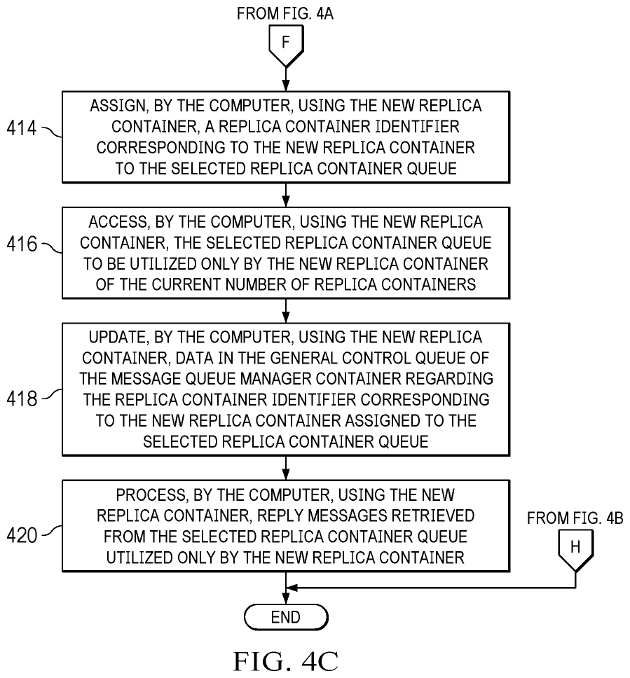

With reference now to FIGS. 4A-4C, a flowchart illustrating a process for starting containers is shown in accordance with an illustrative embodiment. The process shown in FIGS. 4A-4C may be implemented in a computer, such as, for example, computer 101 in FIG. 1 or host computer 202 in FIG. 2. For example, the process shown in FIGS. 4A-4C may be implemented by message aggregation flow control code 200 in FIG. 1.

The process begins when the computer makes a determination as to whether a current number of replica containers in a container-based architecture is less than a predefined number of replica containers for the container-based architecture (step 402). If the computer determines that the current number of replica containers in the container-based architecture is not less than (e.g., equal to) the predefined number of replica containers for the container-based architecture, no output of step 402, then the process returns to step 402 where the computer continues to determine whether the current number of replica containers is less than the predefined number of replica containers or not. If the computer determines that the current number of replica containers in the container-based architecture is less than the predefined number of replica containers for the container-based architecture, yes output of step 402, then the computer adds a new replica container to the current number of replica containers by generating the new replica container (step 404).

The computer, using the new replica container, reads a general control queue of a message queue manager container (step 406). The computer, using the new replica container, identifies a total number of replica container queues that currently exist in the message queue manager container based on reading the general control queue of the message queue manager container (step 408).

The computer, using the new replica container, selects a replica container queue of the total number of replica container queues in the message queue manager container to form a selected replica container queue (step 410). The computer, using the new replica container, makes a determination as to whether the selected replica container queue is available to be utilized only by the new replica container (step 412).

If the computer, using the new replica container, determines that the selected replica container queue is available to be utilized only by the new replica container, yes output of step 412, then the computer, using the new replica container, assigns a replica container identifier corresponding to the new replica container to the selected replica container queue (step 414). In addition, the computer, using the new replica container, accesses the selected replica container queue to be utilized only by the new replica container of the current number of replica containers (step 416). Further, the computer, using the new replica container, updates data in the general control queue of the message queue manager container regarding the replica container identifier corresponding to the new replica container assigned to the selected replica container queue (step 418). Furthermore, the computer, using the new replica container, processes reply messages retrieved from the selected replica container queue utilized only by the new replica container (step 420). Thereafter, the process terminates.

Returning again to step 412, if the computer, using the new replica container, determines that the selected replica container queue is not available to be utilized only by the new replica container, yes output of step 412, then the computer makes a determination as to whether another replica container queue exists in the total number of replica container queues in the message queue manager container (step 422). If the computer determines that another replica container queue does exist in the total number of replica container queues in the message queue manager container, yes output of step 422, then the process returns to step 410 where the computer selects another replica container queue.

If the computer determines that another replica container queue does not exist in the total number of replica container queues in the message queue manager container, no output of step 422, then the computer, using the new replica container, adds a new replica container queue to the total number of replica container queues that currently exist in the message queue manager container by generating the new replica container queue (step 424). The computer, using the new replica container, assigns the replica container identifier corresponding to the new replica container to the new replica container queue added to the total number of replica container queues that currently exist in the message queue manager container (step 426). The computer, using the new replica container, accesses the new replica container queue to be utilized only by the new replica container of the current number of replica containers (step 428). The computer, using the new replica container, updates the data in the general control queue of the message queue manager container regarding the replica container identifier corresponding to the new replica container assigned to the new replica container queue added to the total number of replica container queues that currently exist in the message queue manager container (step 430). The computer, using the new replica container, processes the reply messages retrieved from the new replica container queue utilized only by the new replica container (step 432). Thereafter, the process terminates.

Thus, illustrative embodiments of the present disclosure provide a computer-implemented method, computer system, and computer program product for controlling message aggregation flows. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for controlling message aggregation flows, the computer-implemented method comprising:
responsive to a computer, using a fan-in message flow of an integration engine in a replica container, determining that all of a plurality of independently identifiable related fan-in messages corresponding to an input message requesting information have been received as a complete set of reply messages from a plurality of back-end servers containing the information by a particular set of queues in a message queue manager container based on tracking the plurality of independently identifiable related fan-in messages, retrieving, by the computer using the fan-in message flow of the integration engine in the replica container, the complete set of reply messages containing the information from the particular set of queues in a message queue manager container;
aggregating, by the computer using the fan-in message flow of the integration engine in the replica container, the complete set of reply messages containing the information to generate a single response message containing the information; and
sending, by the computer, the single response message containing the information to a client device requesting the information via a network.

2. The computer-implemented method of claim 1, further comprising:
responsive to the computer, using the fan-in message flow of the integration engine in the replica container, determining that all of the plurality of independently identifiable related fan-in messages corresponding to the input message requesting the information have not been received as the complete set of reply messages from the plurality of back-end servers containing the information by the particular set of queues in the message queue manager container based on the tracking of the plurality of independently identifiable related fan-in messages, determining, by the computer using the fan-in message flow of the integration engine in the replica container, whether a timeout period associated with the fan-in message flow has been exceeded;
responsive to the computer, using the fan-in message flow of the integration engine in the replica container, determining that the timeout period associated with the fan-in message flow has been exceeded, retrieving, by the computer using the fan-in message flow of the integration engine in the replica container, a partial set of reply messages containing the information from the particular set of queues in the message queue manager container; and
aggregating, by the computer using the fan-in message flow of the integration engine in the replica container, the partial set of reply messages containing the information into the single response message containing the information.

3. The computer-implemented method of claim 1, further comprising:
invoking, by the computer, a fan-out message flow of the integration engine in the replica container to send a plurality of independently identifiable related fan-out messages corresponding to an input message requesting information to the plurality of back-end servers containing the information via the particular set of queues in the message queue manager container in response to the computer receiving the input message requesting the information from the client device via the network; and
invoking, by the computer, the fan-in message flow of the integration engine in the replica container to receive the plurality of independently identifiable related fan-in messages corresponding to the input message requesting the information from the plurality of back-end servers containing the information via the particular set of queues in the message queue manager container.

4. The computer-implemented method of claim 3, wherein the particular set of queues in the message queue manager container is utilized only by the replica container, and wherein the replica container is one of a plurality of replica containers running the integration engine in a container-based architecture, each respective replica container of the plurality of replica containers utilizes a different set of queues in the message queue manager container, and wherein each respective replica container of the plurality of replica containers does not have a dedicated persistent storage for tracking the plurality of independently identifiable related fan-out messages corresponding to the input message requesting the information and the plurality of independently identifiable related fan-in messages corresponding to the input message requesting the information.

5. The computer-implemented method of claim 3, further comprising:
tracking, by the computer using the fan-in message flow of the integration engine in the replica container, the plurality of independently identifiable related fan-in messages corresponding to the input message requesting the information; and
determining, by the computer using the fan-in message flow of the integration engine in the replica container, whether all of the plurality of independently identifiable related fan-in messages corresponding to the input message requesting the information have been received as the complete set of reply messages from the plurality of back-end servers containing the information by the particular set of queues in the message queue manager container based on the tracking of the plurality of independently identifiable related fan-in messages.

6. The computer-implemented method of claim 1, further comprising:
adding, by the computer, a new replica container to a current number of replica containers by generating the new replica container in response to the computer determining that the current number of replica containers is less than a predefined number of replica containers;
reading, by the computer using the new replica container, a general control queue of the message queue manager container;
identifying, by the computer using the new replica container, a total number of replica container queues that currently exist in the message queue manager container based on the reading of the general control queue of the message queue manager container; and
selecting, by the computer using the new replica container, a replica container queue of the total number of replica container queues in the message queue manager container to form a selected replica container queue.

7. The computer-implemented method of claim 6, further comprising:
assigning, by the computer using the new replica container, a replica container identifier corresponding to the new replica container to the selected replica container queue in response to the computer, using the new replica container, determining that the selected replica container queue is available to be utilized only by the new replica container;
accessing, by the computer using the new replica container, the selected replica container queue to be utilized only by the new replica container of the current number of replica containers;
updating, by the computer using the new replica container, data in the general control queue of the message queue manager container regarding the replica container identifier corresponding to the new replica container assigned to the selected replica container queue; and
processing, by the computer using the new replica container, reply messages retrieved from the selected replica container queue utilized only by the new replica container.

8. The computer-implemented method of claim 7, further comprising:
determining, by the computer, whether another replica container queue exists in the total number of replica container queues in the message queue manager container in response to the computer, using the new replica container, determining that the selected replica container queue is not available to be utilized only by the new replica container;
adding, by the computer using the new replica container, a new replica container queue to the total number of replica container queues that currently exist in the message queue manager container by generating the new replica container queue in response to the computer determining that another replica container queue does not exist in the total number of replica container queues in the message queue manager container;
assigning, by the computer using the new replica container, the replica container identifier corresponding to the new replica container to the new replica container queue added to the total number of replica container queues that currently exist in the message queue manager container;
accessing, by the computer using the new replica container, the new replica container queue to be utilized only by the new replica container of the current number of replica containers;
updating, by the computer using the new replica container, the data in the general control queue of the message queue manager container regarding the replica container identifier corresponding to the new replica container assigned to the new replica container queue added to the total number of replica container queues that currently exist in the message queue manager container; and
processing, by the computer using the new replica container, the reply messages retrieved from the new replica container queue utilized only by the new replica container.

9. A computer system for controlling message aggregation flows, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
retrieve, using a fan-in message flow of an integration engine in a replica container, a complete set of reply messages containing information from a particular set of queues in a message queue manager container in response to determining, using the fan-in message flow of the integration engine in the replica container, that all of a plurality of independently identifiable related fan-in messages corresponding to an input message requesting the information have been received as the complete set of reply messages from a plurality of back-end servers containing the information by the particular set of queues in the message queue manager container based on tracking of the plurality of independently identifiable related fan-in messages;
aggregate, using the fan-in message flow of the integration engine in the replica container, the complete set of reply messages containing the information to generate a single response message containing the information; and
send the single response message containing the information to a client device requesting the information via a network.

10. The computer system of claim 9, wherein the set of processors further executes the program instructions to:
determine, using the fan-in message flow of the integration engine in the replica container, whether a timeout period associated with the fan-in message flow has been exceeded in response to determining, using the fan-in message flow of the integration engine in the replica container, that all of the plurality of independently identifiable related fan-in messages corresponding to the input message requesting the information have not been received as the complete set of reply messages from the plurality of back-end servers containing the information by the particular set of queues in the message queue manager container based on the tracking of the plurality of independently identifiable related fan-in messages;
retrieve, using the fan-in message flow of the integration engine in the replica container, a partial set of reply messages containing the information from the particular set of queues in the message queue manager container in response to determining, using the fan-in message flow of the integration engine in the replica container, that the timeout period associated with the fan-in message flow has been exceeded; and
aggregate, using the fan-in message flow of the integration engine in the replica container, the partial set of reply messages containing the information into the single response message containing the information.

11. The computer system of claim 9, wherein the set of processors further executes the program instructions to:
invoke a fan-out message flow of the integration engine in the replica container to send a plurality of independently identifiable related fan-out messages corresponding to an input message requesting information to the plurality of back-end servers containing the information via the particular set of queues in the message queue manager container in response to receiving the input message requesting the information from the client device via the network; and
invoke the fan-in message flow of the integration engine in the replica container to receive the plurality of independently identifiable related fan-in messages corresponding to the input message requesting the information from the plurality of back-end servers containing the information via the particular set of queues in the message queue manager container.

12. The computer system of claim 11, wherein the particular set of queues in the message queue manager container is utilized only by the replica container, and wherein the replica container is one of a plurality of replica containers running the integration engine in a container-based architecture, each respective replica container of the plurality of replica containers utilizes a different set of queues in the message queue manager container, and wherein each respective replica container of the plurality of replica containers does not have a dedicated persistent storage for tracking the plurality of independently identifiable related fan-out messages corresponding to the input message requesting the information and the plurality of independently identifiable related fan-in messages corresponding to the input message requesting the information.

13. The computer system of claim 11, wherein the set of processors further executes the program instructions to:
track, using the fan-in message flow of the integration engine in the replica container, the plurality of independently identifiable related fan-in messages corresponding to the input message requesting the information; and
determine, using the fan-in message flow of the integration engine in the replica container, whether all of the plurality of independently identifiable related fan-in messages corresponding to the input message requesting the information have been received as the complete set of reply messages from the plurality of back-end servers containing the information by the particular set of queues in the message queue manager container based on the tracking of the plurality of independently identifiable related fan-in messages.

14. A computer program product for controlling message aggregation flows, the computer program product comprising a set of computer-readable storage media having program instructions collectively stored therein, the program instructions executable by a computer to cause the computer to:
retrieve, using a fan-in message flow of an integration engine in a replica container, a complete set of reply messages containing information from a particular set of queues in a message queue manager container in response to determining, using the fan-in message flow of the integration engine in the replica container, that all of a plurality of independently identifiable related fan-in messages corresponding to an input message requesting the information have been received as the complete set of reply messages from a plurality of back-end servers containing the information by the particular set of queues in the message queue manager container based on tracking of the plurality of independently identifiable related fan-in messages;
aggregate, using the fan-in message flow of the integration engine in the replica container, the complete set of reply messages containing the information to generate a single response message containing the information; and
send the single response message containing the information to a client device requesting the information via a network.

15. The computer program product of claim 14, wherein the program instructions further cause the computer to:
determine, using the fan-in message flow of the integration engine in the replica container, whether a timeout period associated with the fan-in message flow has been exceeded in response to determining, using the fan-in message flow of the integration engine in the replica container, that all of the plurality of independently identifiable related fan-in messages corresponding to the input message requesting the information have not been received as the complete set of reply messages from the plurality of back-end servers containing the information by the particular set of queues in the message queue manager container based on the tracking of the plurality of independently identifiable related fan-in messages;
retrieve, using the fan-in message flow of the integration engine in the replica container, a partial set of reply messages containing the information from the particular set of queues in the message queue manager container in response to determining, using the fan-in message flow of the integration engine in the replica container, that the timeout period associated with the fan-in message flow has been exceeded; and
aggregate, using the fan-in message flow of the integration engine in the replica container, the partial set of reply messages containing the information into the single response message containing the information.

16. The computer program product of claim 14, wherein the program instructions further cause the computer to:
invoke a fan-out message flow of the integration engine in the replica container to send a plurality of independently identifiable related fan-out messages corresponding to an input message requesting information to the plurality of back-end servers containing the information via the particular set of queues in the message queue manager container in response to receiving the input message requesting the information from the client device via the network; and
invoke the fan-in message flow of the integration engine in the replica container to receive the plurality of independently identifiable related fan-in messages corresponding to the input message requesting the information from the plurality of back-end servers containing the information via the particular set of in the message queue manager container.

17. The computer program product of claim 16, wherein the particular set of queues in the message queue manager container is utilized only by the replica container, and wherein the replica container is one of a plurality of replica containers running the integration engine in a container-based architecture, each respective replica container of the plurality of replica containers utilizes a different set of queues in the message queue manager container, and wherein each respective replica container of the plurality of replica containers does not have a dedicated persistent storage for tracking the plurality of independently identifiable related fan-out messages corresponding to the input message requesting the information and the plurality of independently identifiable related fan-in messages corresponding to the input message requesting the information.

18. The computer program product of claim 16, wherein the program instructions further cause the computer to:
track, using the fan-in message flow of the integration engine in the replica container, the plurality of independently identifiable related fan-in messages corresponding to the input message requesting the information; and
determine, using the fan-in message flow of the integration engine in the replica container, whether all of the plurality of independently identifiable related fan-in messages corresponding to the input message requesting the information have been received as the complete set of reply messages from the plurality of back-end servers containing the information by the particular set of queues in the message queue manager container based on the tracking of the plurality of independently identifiable related fan-in messages.

19. The computer program product of claim 14, wherein the program instructions further cause the computer to:
add a new replica container to a current number of replica containers by generating the new replica container in response to determining that the current number of replica containers is less than a predefined number of replica containers;
read, using the new replica container, a general control queue of the message queue manager container;
identify, using the new replica container, a total number of replica container queues that currently exist in the message queue manager container based on reading the general control queue of the message queue manager container; and
select, using the new replica container, a replica container queue of the total number of replica container queues in the message queue manager container to form a selected replica container queue.

20. The computer program product of claim 19, wherein the program instructions further cause the computer to:
assign, using the new replica container, a replica container identifier corresponding to the new replica container to the selected replica container queue in response to determining, using the new replica container, that the selected replica container queue is available to be utilized only by the new replica container;
access, using the new replica container, the selected replica container queue to be utilized only by the new replica container of the current number of replica containers;
update, using the new replica container, data in the general control queue of the message queue manager container regarding the replica container identifier corresponding to the new replica container assigned to the selected replica container queue; and
process, using the new replica container, reply messages retrieved from the selected replica container queue utilized only by the new replica container.
